(19) United States
(12) Patent Application Publication
(10) Pub. No.: US 2006/0036810 A1
(43) Pub. Date: Feb. 16, 2006

(54) System, application and method of reducing cache thrashing in a multi-processor with a shared cache on which a disruptive process is executing

(75) Inventors: Jos Manuel Accapadi, Austin, TX (US); Larry Bert Brenner, Austin, TX (US); Andrew Dunshea, Austin, TX (US); Dirk Michel, Austin, TX (US)

Correspondence Address: IBM CORPORATION (VE);C/O VOLEL EMILE, P. O. BOX 202170, AUSTIN, TX, 78720-2170, US

(73) Assignee: International Business Machines Corporation, Armonk, NY (US)

(21) Appl. No.: 10/916,984

(22) Filed: Aug. 12, 2004

(51) Int. Cl. G06F 12/00; G06F 12/14

(52) U.S. Cl. 711/132

(57) ABSTRACT

A system, apparatus and method of reducing cache thrashing in a multi-processor with a shared cache executing a disruptive process (i.e., a thread that has a poor cache affinity or a large cache footprint) are provided. When a thread is dispatched for execution, a table is consulted to determine whether the dispatched thread is a disruptive thread. If so, a system idle process is dispatched to the processor sharing a cache with the processor executing the disruptive thread. Since the system idle process may not use data intensively, cache thrashing may be avoided.

### CROSS-REFERENCE TO RELATED APPLICATIONS

This application is related to co-pending U.S. patent application Ser. No. ______ (IBM Docket No. AUS920040017), entitled SYSTEM, APPARATUS AND METHOD OF REDUCING ADVERSE PERFORMANCE IMPACT DUE TO MIGRATION OF PROCESSES FROM ONE CPU TO ANOTHER, filed on even date herewith and assigned to the common assignee of this application, the disclosure of which is herein incorporated by reference.

### BACKGROUND OF THE INVENTION

1. Technical Field

The present invention is directed to process or thread processing. More specifically, the present invention is directed to a system, application and method of reducing cache thrashing in a multi-processor with a shared cache on which a disruptive process is executing.

2. Description of Related Art

Caches are sometimes shared between two or more processors. For example, in some dual chip modules two processors may share a single L2 cache. Having two or more processors share a cache may be beneficial in certain instances. Particularly, when processing parallel programs and the processors need to access a particular piece of data, only one processor needs to actually fetch the data into the shared cache. In those instances, therefore, system bus contentions are avoided.

Nonetheless, disruptive processes (i.e., processes that have either a poor cache affinity or a very large cache footprint) may adversely affect performance of such systems. Cache affinity is the concept of using data that is already in a cache while cache footprint is actual cache utilization.

As alluded to above, processes that have a good cache affinity often use data that is already in the cache. The data may be in the cache because it has been fetched during a previous execution of the process or through pre-fetching. Obviously, if a process has poor cache affinity, it will not use data that is already in the cache. Instead, it will fetch the data. Depending on the location of the data (i.e., whether on disk or in main memory etc.) performance may be severely impacted.

Processes that have a large cache footprint may fill up the cache rather quickly. Consequently, previously fetched data may have to be discarded to make room for newly accessed data. If the discarded data is to be reused, it has to be fetched once more into the cache. Then, just as in the case of processes with poor cache affinity, performance may be adversely impacted as data will have to be continually fetched into the cache.

In any case, when these processes run in conjunction with other processes on a system having a shared cache, there is a high likelihood that cache thrashing may occur. Thrashing considerably slows down the performance of a system since a processor has to continually move data in and out of the cache instead of doing productive work.

Consequently, what is needed is a system, apparatus and method of reducing the likelihood of cache thrashing in a multi-processor with a shared cache on which a disruptive process is executing.

### SUMMARY OF THE INVENTION

The present invention provides a system, apparatus and method of reducing cache thrashing in a multi-processor with a shared cache executing a disruptive process (i.e., a thread that has a poor cache affinity or a large cache footprint). As the multi-processor executes threads, it keeps count of the number of processor cycles used to process each instruction (CPI). After the execution of a thread has been suspended, the average CPI is computed and compared to a user-configurable threshold. If the average CPI is greater than the threshold, it is entered into a table that has a list of all the threads being executed on the multi-processor system. The average CPI is then linked to all the threads that were actually executing on the multi-processor system when the high average CPI was exhibited. After dispatching a thread, the table is consulted to determine whether the dispatched thread is a disruptive thread (a disruptive thread is a thread to which the most average CPIs are linked). If the dispatched thread is a disruptive thread, a system idle process is dispatched (when possible) on the processor that shares the cache with the processor executing the disruptive thread.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1a depicts an block diagram illustrating an exemplary data processing system in which the present invention may be implemented.

FIG. 1b depicts another exemplary data processing system in which the present invention may be implemented.

FIG. 2 depicts run queues of the processors in FIG. 1.

FIG. 3 is a table that may be used by the present invention.

FIG. 4 is a flowchart of a process that may be used to fill in the table.

FIG. 5 is a flowchart of a process that may be used by the present invention when a thread is dispatched.

### DETAILED DESCRIPTION OF THE PREFERRED EMBODIMENT

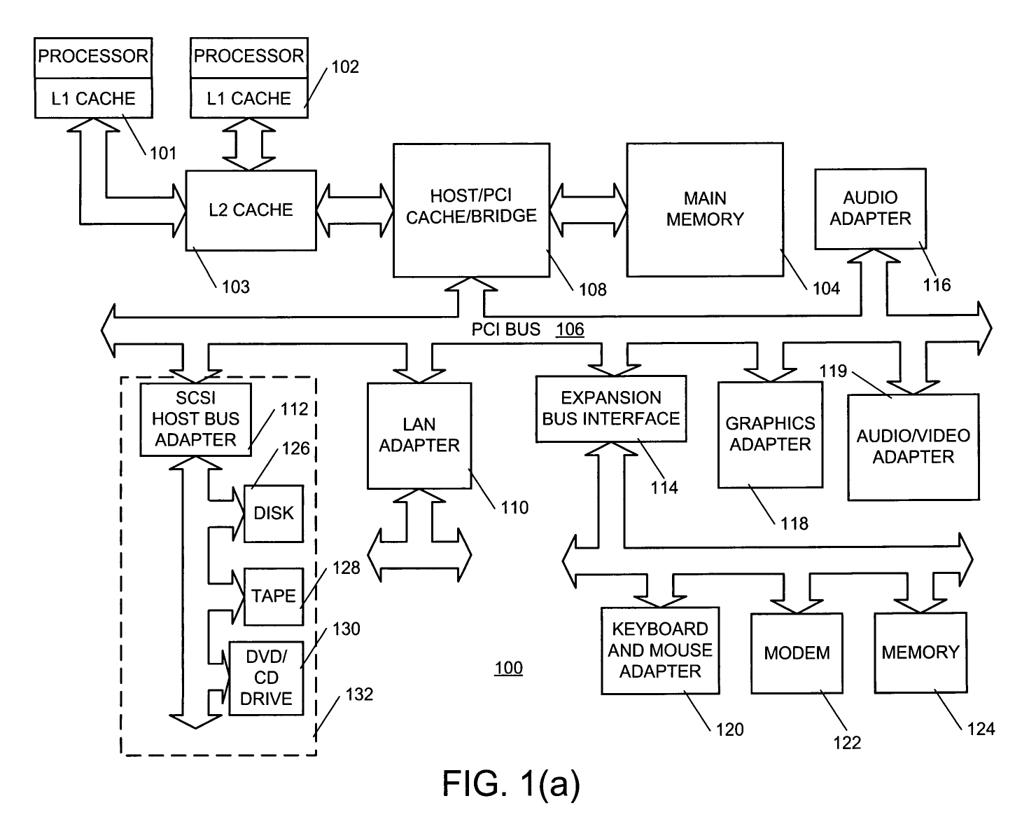

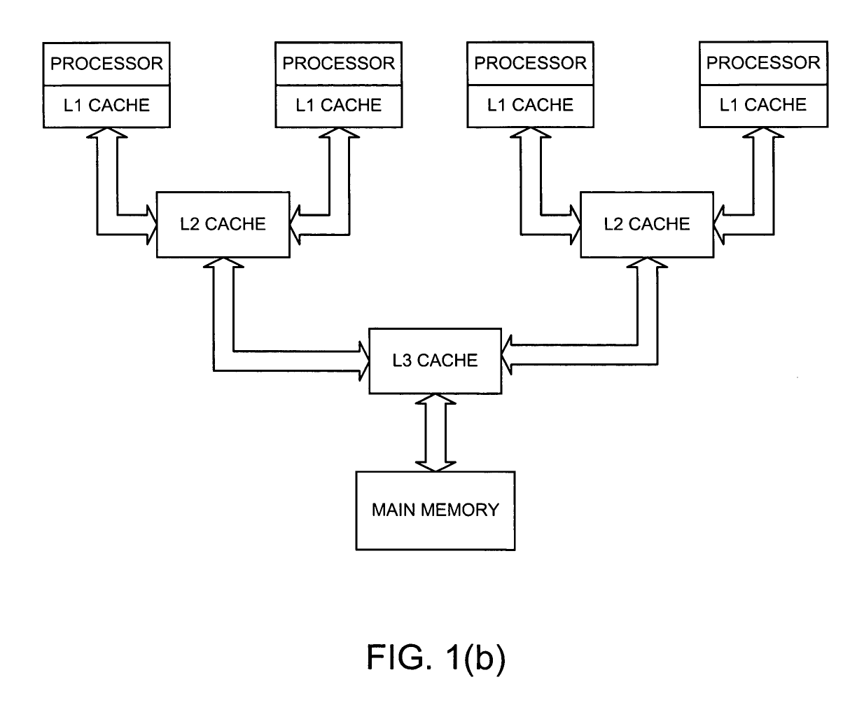

With reference now to figures, FIG. 1a depicts a block diagram illustrating a data processing system in which the present invention may be implemented. Data processing system 100 employs a dual chip module containing processor cores 101 and 102 and peripheral component interconnect (PCI) local bus architecture. In this particular configuration, each processor core includes a processor and an L1 cache. Further, the two processor cores share an L2 cache 103. However, it should be understood that this configuration is not restrictive to the present invention. Other configurations, such that depicted in FIG. 1b, may be used as well. In FIG. 1b each one of two L2 caches is shared by two processors while an L3 cache is shared by all processors in the system.

Returning to FIG. 1a, the L2 cache 103 is connected to main memory 104 and PCI local bus 106 through PCI bridge 108. PCI bridge 108 also may include an integrated memory controller and cache memory for processors 101 and 102. Additional connections to PCI local bus 106 may be made through direct component interconnection or through add-in boards. In the depicted example, local area network (LAN) adapter 110, SCSI host bus adapter 112, and expansion bus interface 114 are connected to PCI local bus 106 by direct component connection. In contrast, audio adapter 116, graphics adapter 118, and audio/video adapter 119 are connected to PCI local bus 106 by add-in boards inserted into expansion slots. Expansion bus interface 114 provides a connection for a keyboard and mouse adapter 120, modem 122, and additional memory 124. Small computer system interface (SCSI) host bus adapter 112 provides a connection for hard disk drive 126, tape drive 128, and CD-ROM/DVD drive 130. Typical PCI local bus implementations will support three or four PCI expansion slots or add-in connectors.

Note that for purpose of simplification processors will be used instead of processor cores. Note further that although the depicted example employs a PCI bus, other bus architectures such as Accelerated Graphics Port (AGP) and Industry Standard Architecture (ISA) may be used.

An operating system runs on processors 101 and 102 and is used to coordinate and provide control of various components within data processing system 100 in FIG. 1a. The operating system may be a commercially available operating system, such as AIX, which is available from International Business Machines Corporation. An object oriented programming system such as Java may run in conjunction with the operating system and provide calls to the operating system from Java programs or applications executing on data processing system 100. “Java” is a trademark of Sun Microsystems, Inc. Instructions for the operating system, the object-oriented operating system, and applications or programs are located on storage devices, such as hard disk drive 126, and may be loaded into main memory 104 for execution by processors 101 and 102.

Those of ordinary skill in the art will appreciate that the hardware in FIG. 1a may vary depending on the implementation. For example, other internal hardware or peripheral devices, such as flash ROM (or equivalent nonvolatile memory) or optical disk drives and the like, may be used in addition to or in place of the hardware depicted in FIG. 1a. Thus, the depicted example in FIG. 1a and above-described examples are not meant to imply architectural limitations.

The operating system generally includes a scheduler, a global run queue, one or more per-processor local run queues, and a kernel-level thread library. A scheduler is a software program that coordinates the use of a computer system's shared resources (e.g., a CPU). The scheduler usually uses an algorithm such as a first-in, first-out (i.e., FIFO), round robin or last-in, first-out (LIFO), a priority queue, a tree etc. algorithm or a combination thereof in doing so. Basically, if a computer system has three CPUs (CPU₁, CPU₂ and CPU₃), each CPU will accordingly have a ready-to-be-processed queue or run queue. If the algorithm in use to assign processes to the run queue is the round robin algorithm and if the last process created was assigned to the queue associated with CPU₂, then the next process created will be assigned to the queue of CPU₃. The next created process will then be assigned to the queue associated with CPU₁ and so on. Thus, schedulers are designed to give each process a fair share of a computer system's resources.

Note that a process is a program. When a program is executing, it is loosely referred to as a task. In most operating systems, there is a one-to-one relationship between a task and a program. However, some operating systems allow a program to be divided into multiple tasks or threads. Such systems are called multithreaded operating systems. For the purpose of simplicity, threads and processes will henceforth be used interchangeably.

Threads must take turns running on a CPU lest one thread prevents other threads from performing work. Thus, another one of the scheduler's tasks is to assign a unit of CPU time (i.e., quantum) to each thread.

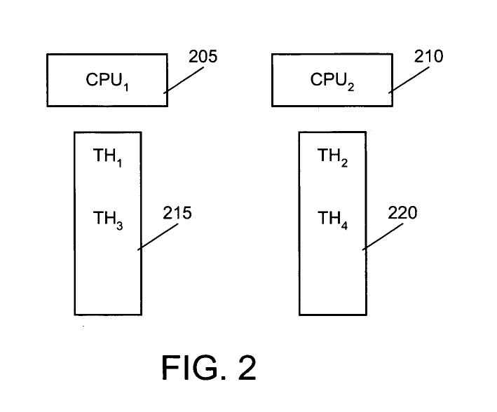

FIG. 2 depicts run queues of the two processors of FIG. 1a. Particularly, CPU₁ 205 represents processor 101 and CPU₂ 210 processor 102. Associated with CPU₁ 205 is run queue 215. Likewise, associated with CPU₂ 210 is run queue 220. In run queue 215 there are two threads that are ready to run (i.e., Th₁ and Th₃) and in run queue 220 threads Th₂ and Th₄ are ready to run. Note that although four threads are shown to be running on the system, many more threads may in fact be in execution. Thus, the number of threads shown is for illustrative purposes only. Further, although Th₁ is disclosed to be processed in conjunction with Th₂ and Th₃ with Th₄, Th₁ may, at any given time, be processed instead with Th₄ and Th₃ with Th₂. This may be due to a variety of reasons, including thread priorities (threads with a higher priority gets to run before threads with a lower priority), threads ceding their processing time to other threads that are ready to run when waiting for something to happen (e.g., for efficiency reasons when a thread is performing I/O work, instead of making the processor wait idly until the I/O is completed, the thread may cede its processing time to another thread and go to sleep. The thread will awaken when the I/O is completed and it is ready to proceed) etc.

Now suppose Th₁ is a disruptive thread (i.e., Th₁ has either a large cache footprint or a poor cache affinity). Suppose further that both Th₁ and Th₂ are dispatched for execution at the same time (i.e., both threads are being executed at the same time). Then, since Th₁ is a disruptive thread, it will request a lot of data. In the mean time, Th₂ may also be requesting data. Hence, the L2 cache 103 may quickly fill up. If the L2 cache 103 is filled up, data being requested anytime thereafter by either processor 101 or processor 102 may have to replace data already in the cache. If either Th₁ or Th₂ needs to reuse data that has been replaced, it will have to fetch the data once more from main memory 104. As a result, both processors may register a high number of cache misses. (A cache miss is a request to read data, which cannot be satisfied from the L2 cache 103 and for which the main memory 104 has to be consulted.)

When the data is brought from main memory 104, it may have to replace other data in the cache that had been brought in by either Th₁ or Th₂. However, modified data in the L2 cache 103 may not be replaced until it has been copied in main memory 104. Hence, in certain instances thrashing may occur. In other words, both processors 101 and 102 may continually be moving data in and out of the L2 cache 103. Consequently, the two processors may register a high number of cycles per instruction (CPI).

The present invention may be used to decrease the number of cache misses and therefore, the CPI that may be used by a processor of a multi-processor system with a shared cache when a thread with a large cache footprint or poor cache affinity is executing thereon. When a thread is executing, the number of cycles it takes to execute an instruction is counted. After the execution of the thread, the average CPI is computed. If the average CPI is greater than a user-configurable threshold, the average CPI may be categorized as a high CPI. All high CPIs are entered into a table that may be used to determine whether a thread is disruptive.

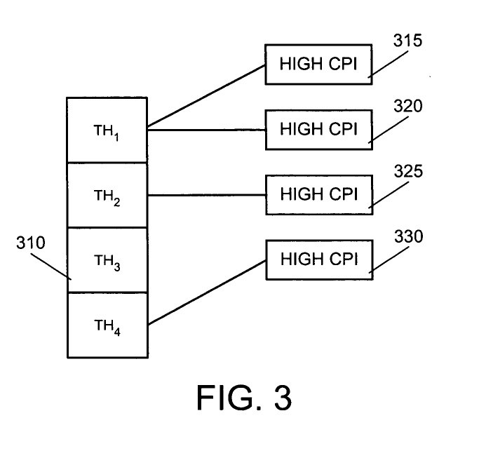

FIG. 3 depicts the above-mentioned table. Column 310 in the table is a list of all the threads that are being executed on the system. Since, as mentioned above, Th₁ is a disruptive thread, when it executes, the system may experience a high average CPI. If this CPI is greater than the user-configurable threshold, an entry (entry 315) will be made into the table. The entry will be linked to Th₁ in column 310. This signifies that when Th₁ was executing the system experienced a high average CPI. If Th₂ was the other thread that was executing with Th₁ on the system then a high CPI entry (entry 325) will be entered and linked to Th₂ in column 310. If, while Th₁ is executing in conjunction with Th₄ the system experiences another high CPI, which is highly likely, then a high CPI entry (entry 320) will be entered and linked to Th₁. Another high CPI entry (entry 330) will be linked to Th₄.

Obviously, an entry 315 will be entered and linked to Th₁ in column 310 of FIG. 3 as many times as the system experiences a high average CPI while executing Th₁. Similarly, an entry 325 or 330 will be linked to either Th₂ or Th₄ in column 310 if either Th₂ or Th₄, respectively, executed with Th₁ when a high average CPI is experienced. Each entry will remain in the table until the time it has been in the table exceeds a user-configurable time span.

In any event, when a thread is dispatched for execution on a processor (i.e., CPU₁ 205), the table is consulted to determine if the thread is a disruptive thread. A thread to which a lot of high CPI entries are linked is considered to be a disruptive thread. If the thread is a disruptive thread, a system idle process is dispatched for execution on the other processor (i.e., CPU₂ 210). Ordinarily, system idle processes run only when no other processes are using the processors. Thus, when a CPU is idle, the system idle process is in action, executing special halt (HLT) instructions that put the CPU into a suspended mode and thereby allowing the CPU to cool down.

In the case of the present invention, however, a system idle process is run on each processor that shares a cache with a processor on which a disruptive thread is executing. Although counter-intuitive, tests have shown that the adverse performance impact that may be exhibited with an idle processor (in the case of two processors sharing a cache) is considerably less than having both processors exhibit a very poor CPI.

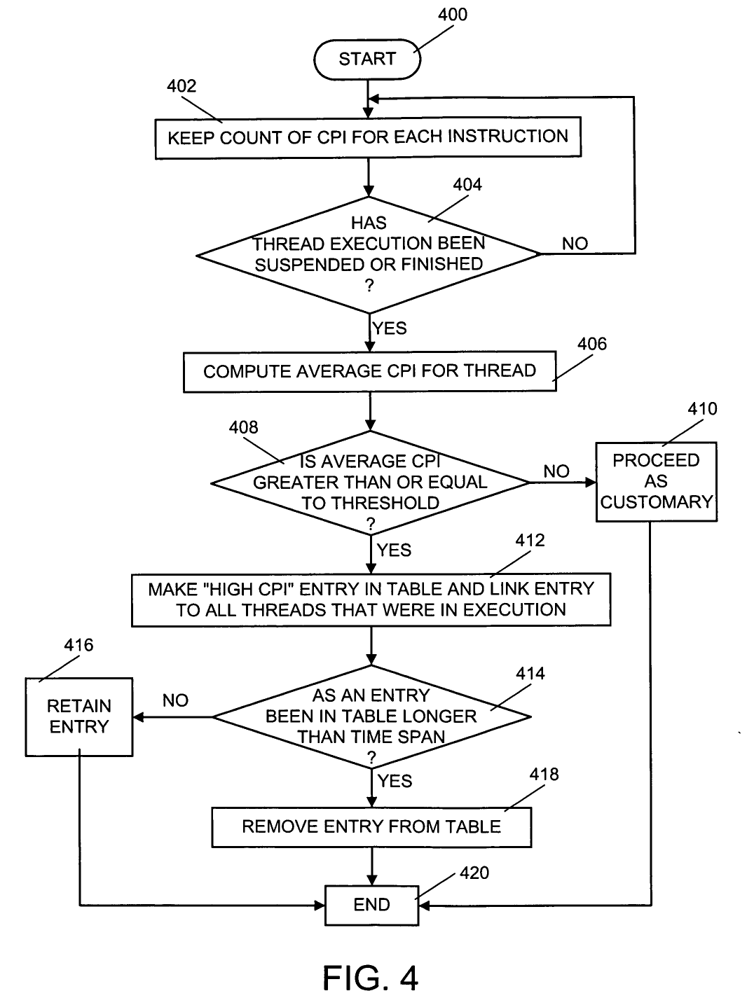

FIG. 4 is a flowchart of a process that may be used to fill in the table. The process starts when a thread is executing (step 400). The process keeps count of the number of cycles it takes for each instruction to execute (CPI) (step 402). When the thread has finished executing, whether or not it is because it has exhausted its quantum, the average CPI is computed for the thread (step 404 and 406). If the average CPI is greater than a user-configurable threshold, a high CPI entry is made to the table. This entry is linked to the threads that executed when the system experienced the high average CPI (steps 408 and 412). At that point a check may be made to determine whether an entry has been there longer than a user-configurable time span. If so, the entry is removed from the table before the process ends (steps 414, 418 and 420). If the entry has been in the table for less than the user-configurable time span, the entry may remain in the table and the process may end (steps 414, 416 and 420). In the case where the average CPI is less than the user-configurable threshold, the process may continue as customary before it ends (408, 410 and 420). Note that the process is repeated for each thread dispatched.

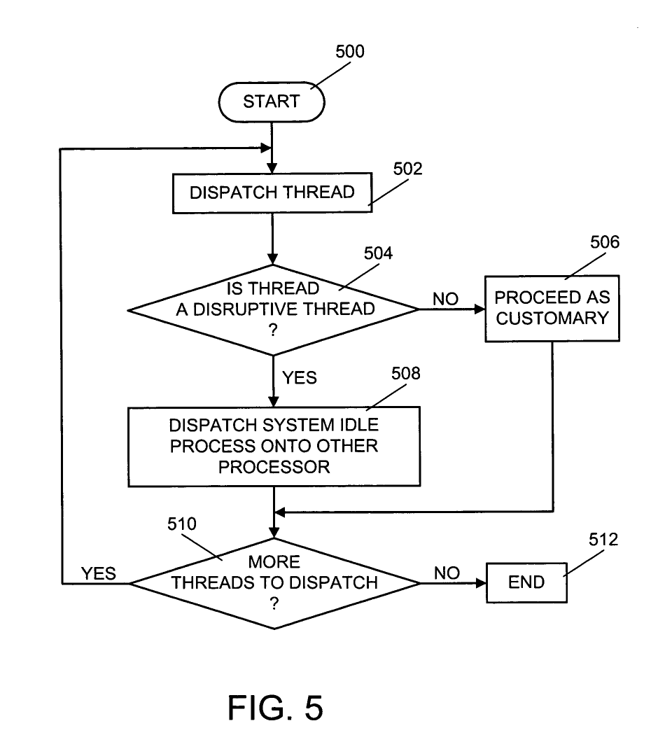

FIG. 5 is a flowchart of a process that may be used by the present invention. The process starts when a thread is dispatched to a processor for execution (steps 500 and 502). Once the thread is dispatched, a check is made to determine whether it is disruptive. If the thread is disruptive, the system idle process may be dispatched, when possible, to the other processor (steps 504 and 508). Then a check is made to determine whether there are more threads to be dispatched. If so, the process jumps back to step 502 (steps 510 and 502). If not, the process ends (steps 510 and 512). If the thread is not a disruptive thread, the process proceeds as customary and jumps to step 510 (steps 504, 506 and 510). The process ends when the system is turned off or is reset.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of reducing cache thrashing in a multi-processor system with a shared cache executing a disruptive thread, the disruptive thread being a thread having a poor cache affinity or a large cache footprint, the method comprising the steps of:
dispatching a thread for execution onto a first processor;
determining whether the dispatched thread is a disruptive thread; and
dispatching, if the thread is a disruptive thread, a system idle process onto a second processor, the second processor sharing a cache with the first processor.

2. The method of claim 1 wherein the determining step includes the steps of:
executing threads;
keeping count of processor cycles used to execute each instruction (CPI) of each thread;
computing an average CPI after each thread execution;
entering the average CPI into a table if the average CPI is greater than a threshold, the threshold being a number of cycles deemed to be unacceptable, the table having a list of all threads being processed by the multi-processor system; and
linking the entered average CPI to all threads in the list of threads that were actually executing when the entered average CPI was exhibited, the thread to which the most average CPIs are linked being a disruptive thread.

3. The method of claim 2 wherein average CPI entries that have been in the tables for longer than a user-configurable time span are deleted from the tables.

4. A method of reducing cache thrashing in a multi-processor with a shared cache executing a disruptive process, the disruptive thread being a thread having a poor cache affinity or a large cache footprint, the method comprising the steps of:
identifying the disruptive thread; and
scheduling the disruptive thread for execution on a processor that shares a cache with a processor executing a system idle process.

5. The method of claim 4 wherein if there is a processor that does not share a cache with other processors, the disruptive thread is scheduled to run on the processor.

6. A computer program product on a computer readable medium for reducing cache thrashing in a multi-processor with a shared cache executing a disruptive thread, the disruptive thread being a thread having a poor cache affinity or a large cache footprint, the computer program product comprising:
code means for dispatching a thread for execution onto a first processor;
code means for determining whether the dispatched thread is a disruptive thread; and
code means for dispatching, if the thread is a disruptive thread, a system idle process onto a second processor, the second processor sharing a cache with the first processor.

7. The computer program product of claim 6 wherein the determining code means includes code means for:
executing threads;
keeping count of processor cycles used to execute each instruction (CPI) of each thread;
computing an average CPI after each thread execution;
entering the average CPI into a table if the average CPI is greater than a threshold, the threshold being a number of cycles deemed to be unacceptable, the table having a list of all threads being processed by the multi-processor system; and
linking the entered average CPI to all threads in the list of threads that were actually executing when the entered average CPI was exhibited, the thread to which the most average CPIs are linked being a disruptive thread.

8. The computer program product of claim 7 wherein average CPI entries that have been in the tables for longer than a user-configurable time span are deleted from the tables.

9. A computer program product on a computer readable medium for reducing cache thrashing in a multi-processor with a shared cache executing a disruptive process, the disruptive thread being a thread having a poor cache affinity or a large cache footprint, the computer program product comprising:
code means for identifying the disruptive thread; and
code means for scheduling the disruptive thread for execution on a processor that shares a cache with a processor executing a system idle process.

10. The computer program product of claim 9 wherein if there is a processor that does not share a cache with other processors, the disruptive thread is scheduled to run on the processor.

11. An apparatus for reducing cache thrashing in a multi-processor with a shared cache executing a disruptive thread, the disruptive thread being a thread having a poor cache affinity or a large cache footprint, the apparatus comprising:
means for dispatching a thread for execution onto a first processor;
means for determining whether the dispatched thread is a disruptive thread; and
means for dispatching, if the thread is a disruptive thread, a system idle process onto a second processor, the second processor sharing a cache with the first processor.

12. The apparatus of claim 11 wherein the means for determining includes means for:
executing threads;
keeping count of processor cycles used to execute each instruction (CPI) of each thread;
computing an average CPI after each thread execution;
entering the average CPI into a table if the average CPI is greater than a threshold, the threshold being a number of cycles deemed to be unacceptable, the table having a list of all threads being processed by the multi-processor system; and
linking the entered average CPI to all threads in the list of threads that were actually executing when the entered average CPI was exhibited, the thread to which the most average CPIs are linked being a disruptive thread.

13. The apparatus of claim 12 wherein average CPI entries that have been in the tables for longer than a user-configurable time span are deleted from the tables.

14. An apparatus for reducing cache thrashing in a multi-processor with a shared cache executing a disruptive process, the disruptive thread being a thread having a poor cache affinity or a large cache footprint, the apparatus comprising:
means for identifying the disruptive thread; and
means for scheduling the disruptive thread for execution on a processor that shares a cache with a processor executing a system idle process.

15. The apparatus of claim 14 wherein if there is a processor that does not share a cache with other processors, the disruptive thread is scheduled to run on the processor.

16. A multi-processor system with a shared cache being able to reduce cache thrashing when executing a disruptive thread, the disruptive thread being a thread having a poor cache affinity or a large cache footprint, the multi-processor system comprising:
at least one storage system for storing code data; and
at least two processors for processing the code data to dispatch a thread for execution onto a first processor, to determine whether the dispatched thread is a disruptive thread, and to dispatch, if the thread is a disruptive thread, a system idle process onto a second processor, the second processor sharing a cache with the first processor.

17. The multi-processor system of claim 16 wherein the code data is further processed to:
execute threads;
keep count of processor cycles used to execute each instruction (CPI) of each thread;
compute an average CPI after each thread execution;
enter the average CPI into a table if the average CPI is greater than a threshold, the threshold being a number of cycles deemed to be unacceptable, the table having a list of all threads being processed by the multi-processor system; and
link the entered average CPI to all threads in the list of threads that were actually executing when the entered average CPI was exhibited, the thread to which the most average CPIs are linked being a disruptive thread.

18. The multi-processor system of claim 17 wherein average CPI entries that have been in the tables for longer than a user-configurable time span are deleted from the tables.

19. A multi-processor system with a shared cache being able to reduce cache thrashing when executing a disruptive process, the disruptive thread being a thread having a poor cache affinity or a large cache footprint, the multi-processor system comprising:
at least one storage device to hold code data; and
at least two processors for processing the code data to identify the disruptive thread, and to schedule the disruptive thread for execution on a processor that shares a cache with a processor executing a system idle process.

20. The multi-processor system of claim 19 wherein if there is a processor that does not share a cache with other processors, the disruptive thread is scheduled to run on the processor.
